(19) United States
(12) Patent Application Publication
(10) Pub. No.: US 2015/0092403 A1
(43) Pub. Date: Apr. 2, 2015

(54) Light Emitting Module, Tube Type Light Emitting Lamp and Luminaire

(71) Applicant: Toshiba Lighting & Technology Corporation, Yokosuka-shi (JP)

(72) Inventors: Tetsuya Ono, Yokosuka-shi (JP); Hiroshi Kubota, Yokosuka-shi (JP); Junichi Kimiya, Yokosuka-shi (JP); Manabu Kika, Yokosuka-shi (JP)

(73) Assignee: TOSHIBA LIGHTING & TECHNOLOGY CORPORATION, Yokosuka-shi (JP)

(21) Appl. No.: 14/200,177

(22) Filed: Mar. 7, 2014

(30) Foreign Application Priority Data
Sep. 30, 2013 (JP) 2013-203215

(51) Int. Cl. F21S 4/00; F21V 21/005

(52) U.S. Cl. CPC F21S 4/008; F21V 21/005
USPC 362/223; 362/382

(57) ABSTRACT

The disclosure is to provide a light emitting module that suppress a dark section from forming in an end portion thereof, a tube type light emitting lamp and a luminaire.

The light emitting module includes a long substrate that has a connection member provided in an end portion thereof in a longitudinal direction; a first light emitting element that is provided on the substrate to line up in a row with the connection member in a short direction; and a second light emitting element that has a light emitting surface area larger than the first light emitting element, and is provided closer to a center side of the substrate in the longitudinal direction than the first light emitting element.

### CROSS-REFERENCE TO RELATED APPLICATIONS

This application is based upon and claims the benefit of priority from the prior Japanese Patent Application No. 2013-203215, filed on Sep. 30, 2013, the entire contents of which are incorporated herein by reference.

### FIELD

Embodiments described herein relate generally to a light emitting module that has a light emitting element as a light source, a tube type light emitting lamp and a luminaire equipped with the tube type light emitting lamp.

### BACKGROUND

A straight tube type fluorescent lamp is used to illuminate an office or the like, but in recent years, a straight tube type LED lamp which has an LED with a low electric power consumption, a low heating value and long life as a light source is used. The straight tube type LED lamp has a plurality of the light emitting modules (LED modules) disposed in a row in a cylindrical glass tube or a cylindrical synthetic resin tube, and the light emitting module has a plurality of the LEDs mounted in a row on a rectangular substrate. The LEDs are mounted at approximately even intervals in a longitudinal direction of the substrate.

The adjacent light emitting modules are electrically connected in series to each other using a connection member or the like.

### BRIEF DESCRIPTION OF THE DRAWINGS

FIG. 1 is a schematic view of a light emitting module of an embodiment.

FIG. 2 is a top view illustrating a part of the adjacent light emitting modules.

FIG. 3 is a cross-sectional view of a tube type light emitting lamp of the embodiment.

FIGS. 4A and 4B are front views of the tube type light emitting lamp of the embodiment.

FIG. 5 is a perspective view of a luminaire of the embodiment.

FIG. 6 is a schematic partial cutaway side view of the luminaire without the tube type light emitting lamp equipped.

### DETAILED DESCRIPTION

There is a problem in that when the connection member or the like is provided in an end portion of the substrate in the longitudinal direction thereof, the connection member is likely to become a dark section. However, when the LED is provided to line up in a row with the connection member in a short direction (a width direction) of the substrate, it is not possible to mount the high-output LED on the substrate since the substrate has a limited space in the short direction.

In view of the above circumferences, an object of an embodiment is to provide a light emitting module, a tube type light emitting lamp and a luminaire equipped with the tube type light emitting lamp, in which a noticeable dark section in a connection portion between the substrates is avoidable.

The light emitting module of the embodiment is configured to have a substrate, a first light emitting element and a second light emitting element.

The substrate has a connection member provided in an end portion thereof in a longitudinal direction. The first light emitting element is provided on the substrate to line up in a row with the connection member in a short direction of the substrate. The second light emitting element has a light emitting surface area larger than that of the first light emitting element, and is provided closer to a center side in the longitudinal direction than the first light emitting element on the substrate. The connection member can be electrically connected to the first and the second light emitting elements, and can electrically connect a plurality of the light emitting modules to each other. It is possible to supply external electric power to the first and the second light emitting elements using the connection member. For example, since the connection member is a connector, the connectors respectively provided on the light emitting modules can be electrically and mechanically connected to each other.

A tubular body has a translucent portion, and contains the light emitting module. A cap has a power supply terminal connected to the light emitting element, and is provided in at least one end portion of the tubular body. For example, the cap with the power supply terminal may be provided in only one end portion or both end portions of the tubular body.

According to the embodiment, when the connection member and the first light emitting element are provided in the end portion of the substrate in the longitudinal direction to line up in parallel with each other in the short direction, and the second light emitting element having a light emitting surface area larger than that of the first light emitting element is provided on the center side of the substrate, it is possible to expect the connection member not to be a noticeable dark section.

Hereinafter, embodiments will be described with reference to the accompanying drawings.

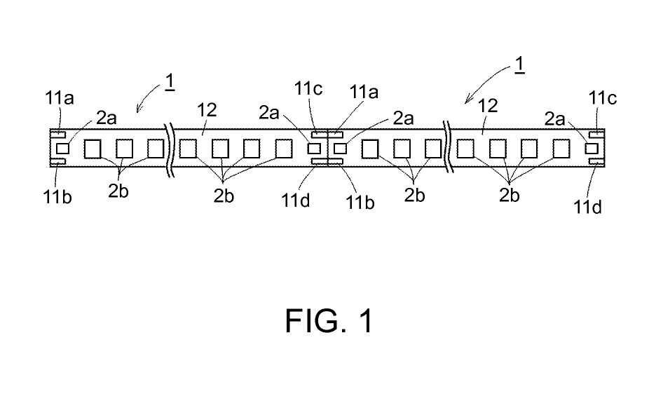

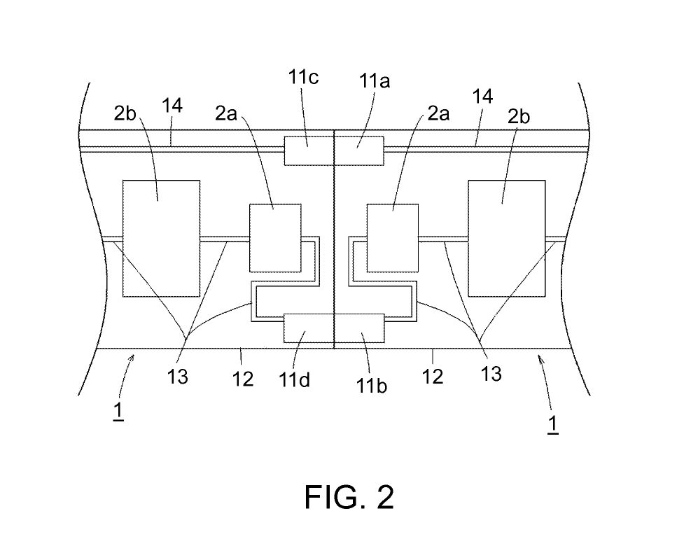

First, a first embodiment will be described with reference to FIGS. 1 and 2.

In each of the drawings, the same reference signs will be assigned to the same portions, and repeated descriptions will be omitted.

In FIGS. 1 and 2, the light emitting module 1 is equipped with a light emitting diode 2a as the first light emitting element, a light emitting diode 2b as the second light emitting element, a substrate 12 on which the light emitting diodes 2a and 2b are mounted, and connection members 11 (11a, 11b, 11c and 11d) that are provided in the end portions of the substrate 12 in the longitudinal direction.

In FIG. 1, for example, two light emitting modules 1 and 1 are connected in series to each other in the longitudinal direction, and the connection members 11 and 11 facing each other are electrically connected to each other. It is possible to connect three or more light emitting modules 1 to each other, and in this case, similarly, the connection members facing each other are electrically connected to each other.

The substrate 12 is a rigid substrate having electric insulation, and is a synthetic resin plate made of a glass epoxy material or the like. For example, the substrate 12 has a dimension in the short direction (width direction) of 20 mm and a dimension in the longitudinal direction of 250 mm to form a long rectangular shape. For example, the substrate 12 has a plate thickness of 1.6 mm. The substrate 12 may be made of metal such as aluminum (Al) which has heat conductivity, or may be a ceramic plate or the like having insulation. When the substrate 12 is made of a member such as metal having electric conductivity, an insulation film or the like is formed at least on a surface of the substrate 12, on which electronic components such as the light emitting diode and the connector are mounted, and on a surface on which a pattern is formed.

For example, the connection member is the connector 11. A pair of the connectors 11 is respectively provided on both end sides of the substrate 12 in the longitudinal direction, and one light emitting module is provided with a total of four connectors 11a, 11b, 11c and 11d. The connectors 11a, 11b, 11c and 11d are provided in such a manner that the male connectors 11a and 11d are positioned to be in point symmetry relationship with the female connectors 11b and 11c. The connectors 11 are configured in such a manner that the connectors 11 can be electrically and mechanically connected to each other in a state where the male connectors and the female connectors face each other. The light emitting modules 1 are configured in such a manner that the light emitting modules 1 are in series disposed in the longitudinal direction, and that the connectors 11c and 11a and the connectors 11d and 11b are electrically and mechanically connected to each other by bringing the connectors 11c and 11a and the connectors 11d and 11b close to each other in state where the connectors 11c and 11a and the connectors 11d and 11b face each other. Accordingly, it is possible to connect the light emitting modules 1 to each other in any case where one end portion of the light emitting modules 1 faces to mate with another end portion thereof in the longitudinal direction.

For example, the light emitting diodes 2a and 2b as the light emitting elements are formed of surface-mounted LED packages that emit white light, and are linearly mounted on a center portion of the substrate 12 in the short direction at even intervals, for example, at 7 mm intervals, along the longitudinal direction.

The light emitting diodes 2a and 2a are provided in the end portion of the substrate 12 in the longitudinal direction to respectively line up in a row with the connectors 11a and 11b and the connectors 11c and 11d in the short direction. The light emitting diode 2b has a light emitting surface area larger than that of the light emitting diode 2a, and is provided closer to the center side in the longitudinal direction than the light emitting diode 2a on the substrate 12. In the embodiment, a pair of the light emitting diodes 2a is provided in each end portion of a row in which the light emitting diodes 2a are provided on the substrate 12 in the longitudinal direction, but when the connectors 11 are provided in only one end portion, the embodiment may be configured to have the light emitting diode 2a provided in only the one end portion.

The adjacent light emitting diodes 2b and 2b, the adjacent light emitting diodes 2a and 2b, the adjacent connector 11b and the light emitting diode 2a, and the adjacent connector 11d and the light emitting diode 2a are electrically connected in series to each other by a wiring pattern 13 that is made of, for example, a copper foil and formed on a surface of the substrate 12. Another wiring pattern 14 to electrically connect the male connector 11a and the female connector 11c is formed on the surface of the substrate 12 along the longitudinal direction. The serial and parallel connections of the wiring pattern 13 to connect the light emitting diodes to each other may be appropriately combined.

In the example of FIG. 1, the connectors 11a and 11b provided on one (left side) light emitting module 1 function as connection terminals for a power supply. The connectors 11c and 11d provided on the other (right side) light emitting module 1 are short-circuited using a jumper wire or the like, which is not illustrated, to form a closed circuit. For example, a direct voltage is applied between the connectors 11a and 11b.

When the light emitting module 1 with this configuration is turned on, the connector 11 protruding from a surface of the substrate causes a shadow and thus, the end portion of the substrate 12 is likely to become a dark section in the entire light emitting module. However, in the embodiment, since the light emitting diode 2a is provided to line up in parallel with the connector 11 in the short direction of the substrate 12, it is possible to prevent the dark section from forming in the end portion.

Furthermore, when the light emitting diode 2a and the connector 11 are provided to line up in a row in the short direction of the substrate 12, reducing the size of the light emitting diode 2a in order to ensure a space for the provision of the connector 11 and an insulation distance is not avoidable. In particular, when a pair of the connectors is provided in the end portion of the substrate 12 in the short direction, and the light emitting diode 2a is provided between the pair of connectors, the size of the light emitting diode 2a is further limited.

In the related art, since in the light emitting module used for illumination, light visual performance is regarded as being important, and the light emitting diodes of the same size are typically provided on a single substrate, when the size of the light emitting diode is limited in a portion of the substrate, for example, when the light emitting diode with a small size and a small light emitting surface area is used, all the light emitting diodes to be mounted have a small size.

However, in the light emitting module 1 of the embodiment, since the light emitting diode 2a is provided to line up in parallel with the connector 11 in the short direction of the substrate 12, and the light emitting diode 2b having a light emitting surface area larger than that of the light emitting diode 2a is provided closer to the center side of the substrate in the longitudinal direction than the light emitting diode 2a, it is possible to provide the light emitting diode with a large light emitting surface area on the light emitting module as a whole, and to prevent the dark section from forming in both end portions of the substrate 12.

If the light emitting diode has the same price, the light emitting diode tends to have higher light emitting efficiency as the size of the light emitting surface area thereof is larger. In the embodiment, it is possible to prevent the dark section from forming in the end portion of the substrate, and to realize the high-efficiency light emitting module.

The first and the second light emitting diodes preferably have an approximately equivalent load voltage.

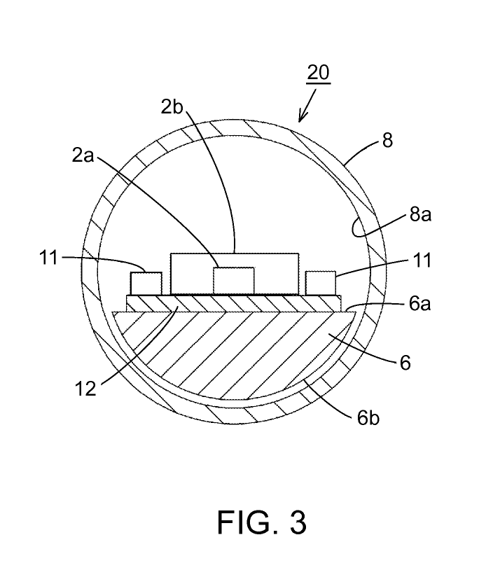

Subsequently, a tube type light emitting lamp 20 of the embodiment will be described with reference to FIGS. 3 to 5.

The tube type light emitting lamp 20 has two light emitting modules 1 and 1 connected to each other in the longitudinal direction, and is attached to an attachment body 6. The attachment body 6 is light, is made of metal such as aluminum (Al) which has high heat conductivity, and is formed in a half cylindrical shape. That is, the attachment body 6 is formed to have a flat surface portion 6a and an arc-shaped surface 6b that aligns with an inner surface 8a of a tubular body 8 to be described later. The attachment body 6 is provided in such a manner that the arc-shaped surface 6b is placed on the inner surface 8a of the tubular body 8. The attachment body 6 engages with a protrusion portion that is formed on the inner surface 8a of the tubular body 8 in the longitudinal direction and is not illustrated and thus, the position of the attachment body 6 is regulated with respect to the tubular body 8.

The tubular body 8 is made of a translucent synthetic resin, for example, a polycarbonate (PC) resin, and, for example, is formed in a cylindrical shape which has an outer diameter of 25 mm and a wall thickness of 1 mm. The tubular body 8 contains the attachment body 6 and the light emitting module 1 attached to the attachment body 6 in the longitudinal direction thereof.

Caps 9 and 10 are made of an electric insulation synthetic resin, for example, polybutylene terephthalate (PBT) resin. The caps 9 and 10 are molded to have a bottomed cylindrical shape with the same outer diameter as that of the tubular body 8, and are respectively provided in both end portions of the tubular body 8. The cap 9 is provided with a pair of power supply terminals 24 and 24, and the cap 10 is provided with one grounding contactor 25.

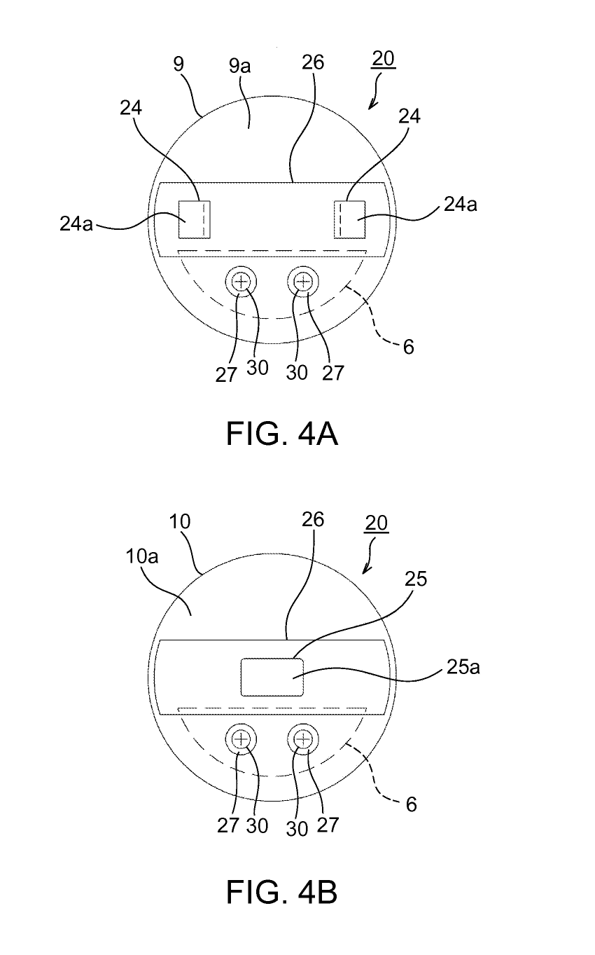

The cap 9 is provided in such a manner that a flat plate-shaped fixation portion 26 protrudes from an outer bottom surface 9a. As illustrated in FIG. 4A, the fixation portion 26 is formed in an approximately rectangular shape, and is provided on a center side of the outer bottom surface 9a. The pair of power supply terminals 24 and 24 is made of, for example, brass, and is formed in an approximate plate shape which has a relatively large thickness.

The pair of power supply terminals 24 and 24 is provided on the fixation portion 26, and is attached to pass through the outer bottom surface 9a of the cap 9. The pair of power supply terminals 24 and 24 is attached to the fixation portion 26 in such a manner that tip end sides 24a and 24a of the power supply terminals 24 and 24 bend to have an L shape, and are formed to keep away from each other.

Screws 30 are inserted into concave portions 27 formed on the outer bottom surface 9a and an outer bottom surface 10a to fix to the attachment body 6 and thus, the caps 9 and 10 and the attachment body 6 are fixed to each other.

As illustrated in FIG. 4B, except for the fact that the grounding contactor 25 is attached to the fixation portion 26, the cap 10 is formed similarly to the cap 9. The grounding contactor 25 is made of, for example, brass and is formed in a pillar shape, for example, in an approximately columnar shape, and a tip end side 25a thereof is formed in an approximately elliptical shape.

For example, each back end portion (not illustrated) of the pair of power supply terminals 24 and 24 is connected to a lead wire by soldering and thus, the power supply terminals 24 and 24 are electrically connected to the connectors.

For example, a back end portion (not illustrated) of the grounding contactor 25 is connected to a lead wire by soldering, and the attachment body 6 and the grounding contactor 25 are electrically connected to each other via the lead wire. The grounding contactor 25 may not be grounded to the attachment body 6. That is, the grounding contactor 25 together with the pair of power supply terminals 24 and 24 may support the tube type light emitting lamp 20 in sockets of the luminaire.

Subsequently, an operation of the embodiment will be described.

When predetermined electric power is supplied to the pair of power supply terminals 24 and 24, the light emitting diode 2 of the light emitting modules 1 and 1 is turned on (emits light), and the tube type light emitting lamp 20 emits visible light, for example, white light. The white light emitted from the light emitting modules 1 and 1 penetrates through the translucent tubular body 8 to be emitted to the outside.

Since the substrate 12 of the light emitting modules 1 and 1 is provided to be adjacent to the flat surface portion 6a of the attachment body 6 substantially without a gap, and the light emitting modules 1 and 1 have the light emitting diodes 2 provided at even intervals in a longitudinal direction of the attachment body 6, each of the light emitting modules 1 and 1 emits light in a substantially uniform manner without the light being discontinued in the longitudinal direction of the tubular body 8. That is, the light emitting diodes 2a can prevent the dark section from occurring in a portion in which the substrates 12 and 12 are connected. Furthermore, since the light emitting diode 2b having a light emitting surface area larger than that of the light emitting diode 2a and high light emitting efficiency is disposed on the center side of the substrate 12, it is possible to realize the high-efficiency tube type light emitting lamp 20 in overall.

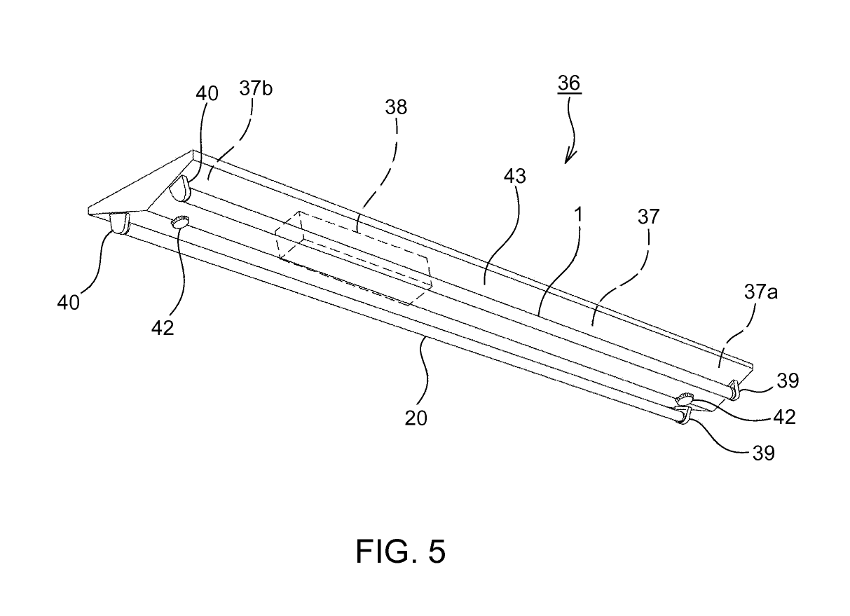

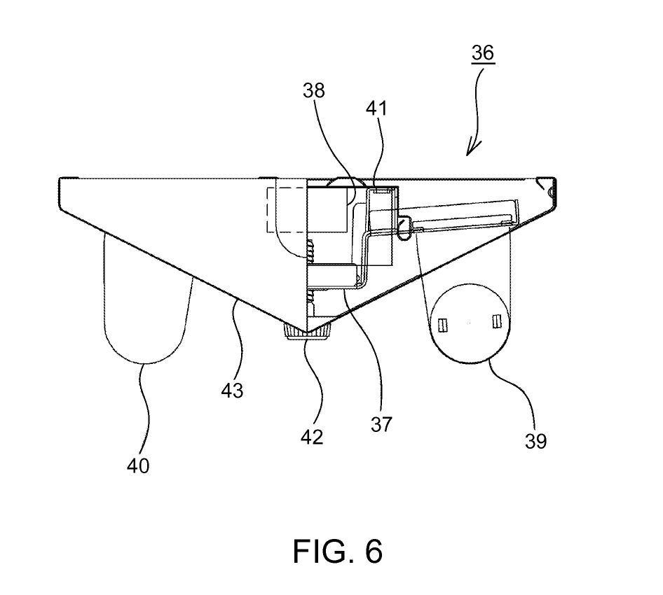

Subsequently, a luminaire of the embodiment will be described with reference to FIGS. 5 and 6.

FIG. 5 is a schematic perspective view of the luminaire, and FIG. 6 is a schematic partial cutaway side view of the luminaire without the tube type light emitting lamp equipped.

A luminaire 36 is installed on a ceiling surface, and is configured to have the tube type light emitting lamp 20, a main luminaire body 37 and a lighting device 38. The main luminaire body 37 is made of a cold rolled steel sheet or the like, and has a well-known configuration in which the main luminaire body 37 is equipped with the straight tube type fluorescent lamp of the related art, except that the main luminaire body 37 is equipped with sockets 39 and 40. The main luminaire body 37 is provided with a pair of the sockets 39 and 40 and two tube type light emitting lamps 20.

The sockets 39 and 40 are attached to both end sides 37a and 37b of the main luminaire body 37 in a longitudinal direction of the main luminaire body 37, and two tube type light emitting lamps 20 are detachably mounted into the sockets 39 and 40.

The socket 39 is formed to have a structure in which the pair of power supply terminals 24 and 24 provided on the cap 9 of the tube type light emitting lamp 20 is inserted into and connected to the socket 39. The other socket 40 is formed to have a structure in which one grounding contactor 25 provided on the cap 10 of the tube type light emitting lamp 20 is inserted into and connected to the socket 40.

The main luminaire body 37 includes a base 41 that is attached onto a ceiling surface by a screw or the like which is not illustrated, and a reflector 43 that is fixed to the main luminaire body 37 by a screw 42. The base 41 is formed in an approximately long rectangular shape, and the reflector 43 is formed in a long box shape, the cross-section of which orthogonal to the longitudinal direction has an approximately pentagonal shape.

The lighting device 38 is attached to the base 41. The lighting device 38 has an input wire, which is not illustrated, connected to an external commercial AC power supply. A pair of output wires which is not illustrated is connected to the socket 39, and a ground wire which is not illustrated is connected to the other socket 40. The lighting device 38 is provided in the main luminaire body 37 in this way. The lighting device 38 has a well-known configuration in which the lighting device 38 supplies a predetermined electric current to the tube type light emitting lamp 20 to turn on the light emitting diode 2.

The luminaire 36 of the embodiment can irradiate from the main luminaire body 37 in the longitudinal direction with approximately uniform illumination light to suppress the dark section from occurring.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light emitting module comprising:
a long substrate that has a connection member provided in an end portion thereof in a longitudinal direction;
a first light emitting element that is provided on the substrate to line up in a row with the connection member in a short direction; and
a second light emitting element that has a light emitting surface area larger than the first light emitting element, and is provided closer to a center side of the substrate in the longitudinal direction than the first light emitting element.

2. The module according to claim 1,
wherein the connection member is electrically connected to the first and the second light emitting elements, and a plurality of the light emitting modules are electrically connected to each other.

3. The module according to claim 1,
wherein external electric power is supplied to the first and the second light emitting elements via the connection member.

4. The module according to claim 1,
wherein the connection member is a connector, and the connectors that are respectively provided on the plurality of light emitting modules are electrically and mechanically connected to each other.

5. The module according to claim 1,
wherein the first light emitting element, a plurality of the second light emitting elements and the connection member are connected in series to each other.

6. The module according to claim 1,
wherein the first light emitting element is provided between a pair of the connection members that are provided on the end portion of the substrate in the longitudinal direction.

7. The module according to claim 1,
wherein the first light emitting elements are respectively provided on both end portions of the long substrate.

8. The module according to claim 1,
wherein the connection member is provided to protrude from the substrate.

9. The module according to claim 1,
wherein the first and the second light emitting elements are light emitting diodes.

10. A tube type light emitting lamp comprising:
a plurality of the light emitting modules according to claim 1 in which the connection members are electrically connected to each other;
a tubular body that has a translucent portion which contains the light emitting module; and
a cap that has a power supply terminal to supply electric power to the first and the second light emitting elements, and is provided in at least one end portion of the tubular body.

11. A luminaire comprising:
the tube type light emitting lamp according to claim 10;
a main luminaire body that has a socket to which the cap of the tube type light emitting lamp is connected; and
a lighting device that turns on the tube type light emitting lamp.
